(19) United States
(12) Patent Application Publication
(10) Pub. No.: US 2019/0259057 A1
(43) Pub. Date: Aug. 22, 2019

(54) GRADUATED FEATURE TRANSITIONS

(71) Applicants: Stacey Kapadia, Mountain View, CA (US); Ariel H. Bardin, Belmont, CA (US); Raymond J. Ryan, San Francisco, CA (US); Balen W. Gore, San Francisco, CA (US); Nadine Harik, Palo Alto, CA (US); Susanne Brokaw, Los Gatos, CA (US)

(72) Inventors: Stacey Kapadia, Mountain View, CA (US); Ariel H. Bardin, Belmont, CA (US); Raymond J. Ryan, San Francisco, CA (US); Balen W. Gore, San Francisco, CA (US); Nadine Harik, Palo Alto, CA (US); Susanne Brokaw, Los Gatos, CA (US)

(73) Assignee: Google Inc., Mountain View, CA (US)

(21) Appl. No.: 12/110,444

(22) Filed: Apr. 28, 2008

Related U.S. Application Data
(60) Provisional application No. 60/949,194, filed on Jul. 11, 2007.

(51) Int. Cl. G06Q 30/02; G06F 16/9535

(52) U.S. Cl. CPC G06Q 30/0251; G06F 16/9535

(57) ABSTRACT

A user interface exposes an application feature of an advertising management application. A graduation trigger is identified, the graduation trigger providing a basis for exposing an additional application feature. The user interface is modified to expose the additional application feature based on the graduation trigger.

### CROSS-REFERENCE TO RELATED APPLICATION

This application claims priority to U.S. Provisional Patent Application Ser. No. 60/949,194 filed Jul. 11, 2007, and entitled “GRADUATED FEATURE TRANSITIONS,” the contents of which are incorporated herein by reference.

### BACKGROUND

Computer applications and other systems sometimes offer various modes that differ in complexity and offer different levels of access to available features. For example, an “advanced” mode may present an assortment (e.g., all) of the available features while a “simple” mode may present some subset of those features and provide a more simplified interface to the system.

To utilize certain features, users may need to choose between different interface modes. For example, a user may need to upgrade from a simple mode to an advanced mode in order to gain access to a particular feature. This transition may be abrupt, since the different interface modes may offer vastly different feature sets and differ in complexity and functionality.

### SUMMARY

In one general aspect, a computer-implemented method comprises: providing a user interface that exposes an application feature of an advertising management application; identifying a graduation trigger based on advertisements associated with a user account, the graduation trigger providing a basis for exposing an additional application feature; and modifying the user interface to expose the additional application feature based on the graduation trigger.

In another general aspect, a system comprises an advertising management module with which users maintain advertising accounts. The advertising management module is configured to: provide a user interface that exposes an advertising feature; identify a graduation trigger based on advertisements associated with a user account, the graduation trigger providing a basis for exposing an additional feature; and modify the user interface to expose the additional feature based on the graduation trigger.

In another general aspect, a system comprises: means for providing, through a user interface, access to an application feature of an advertising management application; means for identifying a graduation trigger based on advertisements associated with a user account, the graduation trigger providing a basis for exposing an additional application feature; and means for providing, through the user interface, access to the additional application feature in response to the identified graduation trigger.

In another general aspect, a computer readable medium stores a computer program. The computer program includes instructions that, when executed, cause at least one processor to: provide, through a user interface, access to an application feature of an advertising management application; identify a graduation trigger, the graduation trigger providing a basis for exposing an additional application feature; and provide, through the user interface, access to the additional application feature in response to the identified graduation trigger.

In another general aspect, a computer-implemented method comprises: providing, through an interface, access to a feature of an application providing sponsored-content to users; identifying a graduation trigger based on at least sponsored-content associated with a user account, the graduation trigger providing a basis for exposing an additional feature; and providing, through the interface, access to the additional feature in response to the identified graduation trigger.

The details of one or more implementations are set forth in the accompanying drawings and the description below. Other features and advantages will be apparent from the description and drawings as well as from the claims.

### BRIEF DESCRIPTION OF THE DRAWINGS

The accompanying drawings show features of implementations consistent with this disclosure and, together with the corresponding description, help explain principles associated with the disclosure.

FIG. 1 is a block diagram depicting an example advertising environment.

FIG. 2 is a diagram illustrating an example data flow within an advertising environment.

FIG. 3 is a flow diagram depicting an example feature transition process.

FIGS. 4, 6 and 7 are illustrations of example user interface displays.

FIG. 5 is a diagram depicting example user interface structures.

FIG. 8 is a block diagram of an example data processing system configuration.

FIG. 9 is a block diagram of an example application layer configuration.

FIG. 10 is a block diagram of an example user access device configuration.

### DESCRIPTION

The following description refers to the accompanying drawings, in which, in the absence of a contrary representation, the same numbers in different drawings represent similar elements.

In some implementations, features of an application are gradually provided or exposed to users through an application frontend as the features become useful or relevant to the user. In this fashion, users may follow a gradual or progressive path through application functionality rather than choosing between simple and advance application modes. In some examples, entry points in a user interface for exposing more complex features can be identified, so that advanced features of the application can be provided to those users who need them as those users need them. Users may be provided with descriptions of available features and options for adopting or utilizing additional features. Features can gradually become available, and some features may be exposed depending on the adoption of other features. For example, if a first feature of an application is adopted by a user, then an additional feature may be exposed based on that adoption.

In some implementations, features and interfaces can be gradually removed or simplified. For example, features can be removed as those features become irrelevant. A determination to remove or simplify features and interfaces may be made based on explicit user commands, inferred information, user account status, feature usage information, and other criteria.

In some implementations, other actions or items may be gradually exposed in addition to application features. In some examples, various help items can be exposed or provided to users. The help items can include help bubbles, callouts, mini-tutorials, and the like. Access to a help center can also be provided. Various other tools, messages, tutorials and the like can also be exposed to users. These other items (e.g., help items) can be exposed at various times, such as when additional features are exposed. For example, a tutorial explaining an additional feature may be exposed when that additional feature is exposed.

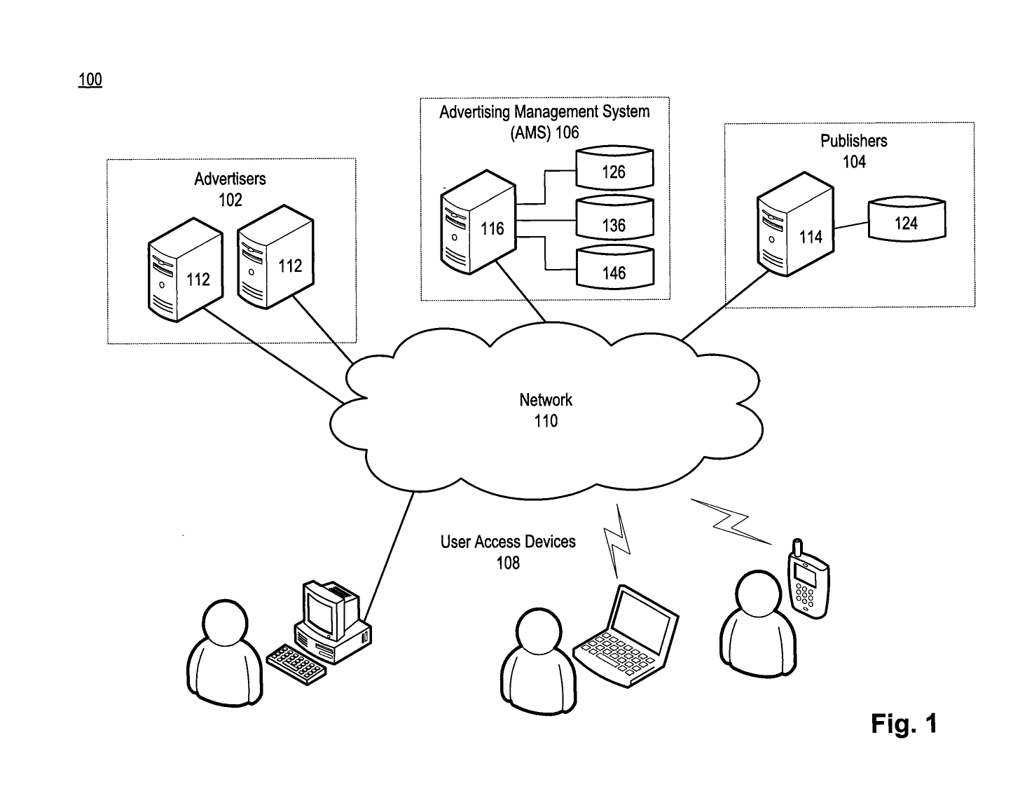

With reference to FIG. 1, an example advertising environment 100 may include one or more advertisers 102, one or more publishers 104, an ad management system (AMS) 106, and one or more user access devices 108, which may be coupled to a network 110. The environment 100 is merely an example, and this disclosure is not limited to advertising. Other forms of content, including other forms of sponsored content, can be delivered by the system. Further, aspects of this disclosure may be used with various other advertising and non-advertising environments, systems and devices.

Each of the elements 102, 104, 106, 108 and 110 in FIG. 1 may be implemented or associated with hardware components, software components, or firmware components or any combination of such components. The elements 102, 104, 106, 108 and 110 could, for example, be implemented or associated with general purpose servers, software processes and engines, and/or various embedded systems.

The advertisers 102 may include any entities that are associated with advertisements (“ads”). An advertisement or an “ad” refers to any form of communication in which one or more products, services, ideas, messages, people, organizations or other items are identified and promoted (or otherwise communicated). Ads are not limited to commercial promotions or other communications. An ad may be a public service announcement or any other type of public notice, such as a public notice published in printed or electronic press or a broadcast. An ad may be referred to or include sponsored-content.

Ads may be communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

The advertisers 102 may provide (or be otherwise associated with) products and/or services related to ads. The advertisers 102 may include or be associated with, for example, retailers, wholesalers, warehouses, manufacturers, distributors, health care providers, educational establishments, financial establishments, technology providers, energy providers, utility providers, or any other product or service providers or distributors.

The advertisers 102 may directly or indirectly generate, maintain and/or track ads, which may be related to products or services offered by or otherwise associated with the advertisers. The advertisers 102 may include or maintain one or more data processing systems 112, such as servers or embedded systems, coupled to the network 110. The advertisers 102 may include or maintain one or more processes that run on one or more data processing systems.

The publishers 104 may include entities that generate, maintain, provide, present and/or otherwise process content in the environment 100. In some implementations, the publishers 104 may include content providers with an Internet presence, such as online publication and news providers (e.g., online newspapers, etc.), online service providers (e.g., financial service providers, health service provider, etc,), and the like. The term “content” refers to various types of web-based and/or otherwise presented information, such as articles, discussion threads, reports, analyses, financial statements, music, video, graphics, search results, web page listings, information feeds (e.g., RSS feeds), television broadcasts, radio broadcasts, printed publications, etc.

The publishers 104 may receive requests from the user access devices 108 (or other elements in the environment 100) and provide or present content to the requesting devices. The publishers may provide or present content via various mediums and in various forms, including web based and non-web based mediums and forms. The publishers 104 may generate and/or maintain such content and/or retrieve the content from other network resources.

In addition to content, the publishers 104 may be configured to integrate or combine retrieved content with ads that are related or relevant to the retrieved content for display to users. These relevant ads may be provided from the AMS 106 and be combined with content for display to users. As described further below, the user access devices 108 may also process ads for display to users. In some examples, the publishers 104 may retrieve an article for display on a particular user access device 108 and then forward the article to the user access device 108 along with code that causes one or more ads from the AMS 106 to be displayed to the user. In other examples, the publishers 104 may retrieve an article, retrieve one or more relevant ads (e.g., from the AMS 106 or the advertisers 102), and then integrate the ads and the article to form a content page for display to the user.

In some implementations, one or more of the publishers 104 may represent a content network that is associated with the AMS 106. In such an implementation, the advertisers 102 may be able to present ads to users through this content network.

The publishers 104 may include or maintain one or more data processing systems 114, such as servers or embedded systems, coupled to the network 110. They may include or maintain one or more processes that run on data processing systems. In some examples, the publishers 104 may include one or more content repositories 124 for storing content and other information.

The AMS 106 manages ads and provides various services to the advertisers 102, the publishers 104, and the user access devices 108. The AMS 106 may store ads in an ad repository 126 and facilitate the distribution of ads through the environment 100 to the user access devices 108. In some configurations, the AMS 106 may include or access functionality associated with the AdWords™ and AdSense™ systems provided by Google, Inc. (Mountain View, Calif.). The AMS 106 may include one or more data processing systems 116, such as servers or embedded systems, coupled to the network 110. It could also include one or more processes, such as server processes.

The AMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publisher content, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query.

The AMS 106 provides various advertising management features to the advertisers 102. In some examples, the AMS 106 may include features for advertisers similar to those in the AdWords™ system provided by Google, Inc. The AMS 106 advertising features may allow users to set up user accounts, set account preferences, create ads, select keywords for ads, create campaigns or initiatives for multiple products or businesses, view reports associated with accounts, analyze costs and return on investment, target customers in different regions, target ads to particular publishers, track financial information, track ad performance, estimate ad traffic, access keyword tools, add graphics and animations to ads, etc.

The AMS 106 may allow the advertisers 102 to create ads and input keywords for which those ads will appear. In some examples, the AMS 106 may provide ads to user access devices or publishers when keywords associated with those ads are included in a user request or requested content. The AMS 106 may also allow the advertisers 102 to set “bids” for ads. A bid may represent the maximum amount an advertiser is willing to pay for each ad impression, user click-through of an ad or other interaction with an ad. A click-through can include any action a user takes to select an ad. The advertisers 102 may also choose a currency and monthly budget.

The AMS 106 may also allow the advertisers 102 to view information about ad impressions, which may be maintained by the AMS 106. The term ad “impression” refers to any form of presentation of an ad such that it is viewable to a user. In some examples, an ad impression may occur when an ad is displayed on a display device of a user access device. The AMS 106 may be configured to determine and maintain the number of ad impressions relative to a particular website or keyword. The AMS 106 may also determine and maintain the number of click-throughs for an ad as well as the ratio of click-throughs to impressions of an ad.

The AMS 106 may also allow the advertisers 102 to select and/or create conversion types for ads. A “conversion” may occur when a user consummates a transaction related to a given ad. A conversion could be defined to occur when a user clicks on an ad, is referred to the advertiser's web page, and consummates a purchase there before leaving that web page. In another example, a conversion could be defined as the display of an ad to a user and a corresponding purchase on the advertiser's web page within a predetermined time (e.g., seven days). The AMS 106 may store conversion data and other information in a conversion data repository 136.

The AMS 106 may allow the advertisers 102 to input description information associated with ads. This information could be used to assist the publishers 104 in determining ads to publish. The advertisers 102 may additionally input a cost/value associated with selected conversion types, such as a five dollar credit to the publishers 104 for each product or service purchased.

The AMS 106 may provide various features to the publishers 104. The AMS 106 may allow the publishers 104 to search and select specific products and services as well as associated ads to be displayed with content provided by the publishers 104. For example, the publishers 104 may search through ads in the ad repository 126 and select certain ads and block or filter out other ads. The AMS 106 may contextually determine or recommend specific items and ads based on, for example, relevance to the publishers site content. The AMS 106 may also determine specific items and ads based on user information and behavior, such as particular search queries performed on a search engine website, a geographical location of the user, etc. The AMS 106 may store user-related information (e.g., personal profiles of users, geographic locations of users, ad context information) in a general data repository 146. A combination of these and other approaches can also be used to provide ads to the publishers 104.

The AMS 106 may be configured to target ads created by the advertisers 102 to the user access devices 108 directly or through the publishers 104. The AMS 106 may target ads to a particular publisher 104 or a requesting user access device 108 when a user requests search results or loads content from the publisher 104.

In some configurations, the AMS 106 may target ads using a searching portion and a content portion. The searching portion may include one or more elements for providing various searching features to the user devices 108 and targeting ads to users based on search terms. The content portion may include one or more elements for targeting ads to users based on content rather than specific terms. The content portion may target ads based on content provided by the publishers 104.

The AMS 106 may be configured to identify relevant ads for targeting using various information, such as ad keywords, content keywords, geographic information, web page identifiers and/or content indices. As an example, the AMS 106 can receive a URL of a requested content page (e.g., from the user access device 108 or the publisher 104). The AMS 106 may match the URL to indexed content keywords associated with the URL to determine a user interest. The AMS 106 may then match the user interest with ads in the repository 126 relevant to the interest. The AMS 106 may, for example, use ad keywords from the advertisers 102 and/or other ad information to identify the ads. The AMS 106 could compare ad keywords from the advertisers 102 or other information to content keywords and/or content in the content page to identify relevant ads. In some examples, the ad selections and preferences specified by the publishers 104 can be used by the AMS 106 when it selects relevant ads.

In some implementations, the AMS 106 may manage and process financial transactions among and between elements in the environment 100. For example, the AMS 106 may credit accounts associated with the publishers 104 and debit accounts of the advertisers 102. These and other transactions may be based on conversion data, impressions information and/or click-through rates received and maintained by the AMS 106.

The AMS 106 may include one or more interface or frontend modules for providing the various features to advertisers, publishers, and user access devices. For example, the AMS 106 may provide one or more advertiser frontends for allowing advertisers to create and manage ads and one or more publisher frontends for allowing publishers to select ads for presentation. In some examples, the frontends may be configured as web applications that provide users with network access to features available in the AMS 106.

The interface modules in the AMS 106 may be configured to gradually or progressively expose features of the AMS 106 to users as features become useful or relevant to the users. For example, an advertiser frontend may initially provide a user interface (e.g., a GUI) exposing a set of basic advertising features to an advertiser 102. The advertiser frontend may then dynamically and gradually expose additional features to the advertiser 102 as those additional features become relevant. The relevance of additional features may be based on various factors, including advertiser account and ad performance statistics maintained by various systems in the AMS 106. In some implementations, the interface modules may communicate with various systems in the environment 100 to determine feature relevance and identify bases for exposing additional features.

As an example of a progressive feature exposure, an advertiser frontend may initially provide a user interface exposing features for creating a single textual ad, selecting keywords for the ad, selecting a single geographic region for ad placement, setting currency and bids and setting monthly budgets. Since this initial feature set allows an advertiser to create only a single ad, the user interface may be presented with a simplified structure showing only the single ad and its keywords. The advertiser frontend may then provide an option for accessing additional features that would enable the advertiser to create additional ads. If the advertiser 102 then adopts this additional feature and creates additional ads, the advertiser frontend may modify the user interface and expose additional features relevant to multiple ads. The user interface could arrange the ads in a hierarchical organization. For example, the user interface could allow the advertiser to create multiple ads under a single initiative or campaign.

The advertiser frontend may then provide an option for accessing additional features for creating multiple campaigns. If the advertiser selects this option, then the user interface can change to group ads and their keywords into ad groups, which can be part of multiple ad initiatives or campaigns. In this fashion, the advertiser frontend exposes features and interface complexity for creating and managing multiple ads to those users interested in creating multiple ads while allowing an advertiser with a single ad to use a simplified interface and feature set.

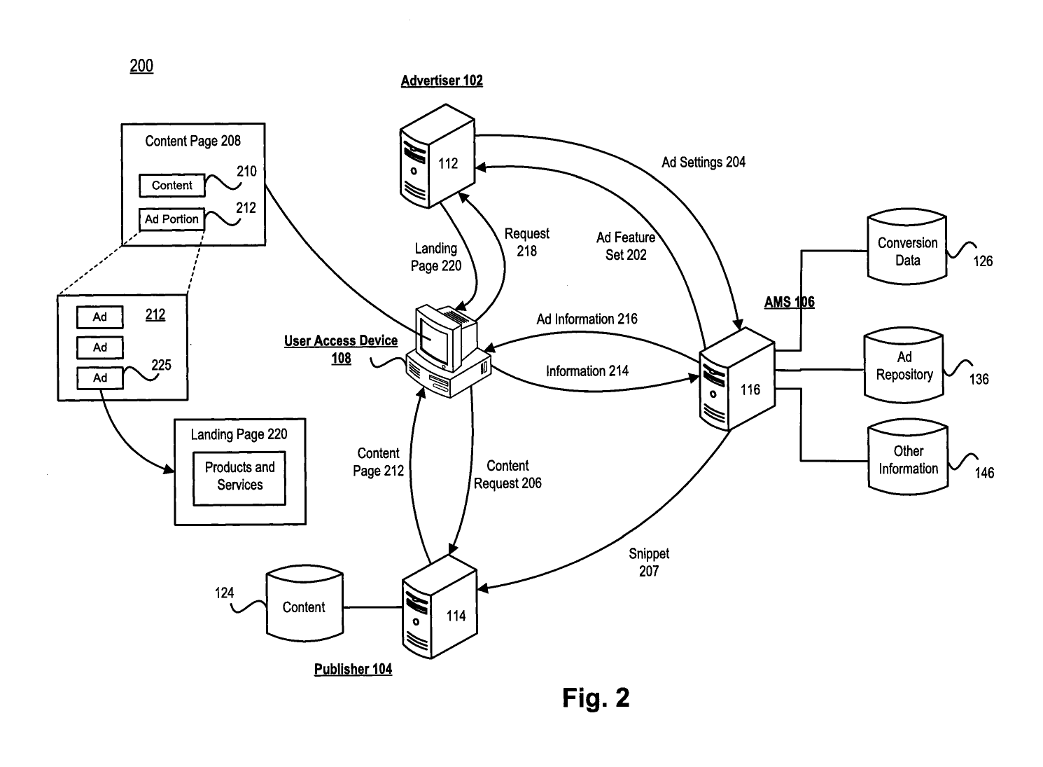

As another example, the advertiser frontend may initially expose features that automatically optimize bidding for advertisers. The advertiser frontend may then provide an option for manually entering bids. If the advertiser chooses to manually enter bids, then the frontend may expose additional features related to keyword bidding. In this fashion, users may follow a gradual path through application functionality. Additional details of gradually exposing features is discussed below in connection with FIGS. 2-9.

Continuing to refer to FIG. 1, the user access devices 108 may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed advertisers 102, publishers 104 and/or user access devices 108, which may be discrete, integrated modules or distributed systems. Similarly, the environment 100 is not limited to a single AMS 106 and may include any number of integrated or distributed AMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes run on separate machines or a single process running on a single machine.

FIG. 2 illustrates an example data flow 200 within the environment 100. The data flow 200 is an example only and not intended to be restrictive. Other data flows may therefore occur in the environment 100 and, even with the data flow 200, the illustrated events and their particular order in time may vary.

In the data flow 200, the AMS 106 provides an ad feature set 202 to one or more advertisers 102. The feature set 202 can include features for creating ads, selecting keywords, targeting locations for ads, setting currency and bids and setting monthly budgets. The AMS 106 may receive ad settings 204 from the advertisers 102. The ad settings 204 may include, for example, information for creating an ad, ad keywords, location targeting information, and pricing information.

During the data flow 200, a particular publisher 104 may receive a content request 206 from a particular user access device 108. The content request 206 may, for example, include a request for an article on a given topic (e.g., automobiles). In response to the request 206, the publisher 104 may retrieve relevant content (e.g., an automobile article) from the content repository 124 or some other source.

The publisher 104 may respond to the content request 206 by sending a content page 208 or other presentation to the requesting user device 108. The content page 208 may include the requested content 210 (e.g., the automobile article) as well as a code “snippet” 207 associated with an ad. A code “snippet” refers, for example, to a method used by one device (e.g., a server) to ask another device (e.g., a browser running on a client device) to perform actions after or while downloading information. In some examples, a code “snippet” may be implemented in JavaScript® code or may be part of HTML (Hypertext Markup Language) or other web page markup language or content.

The AMS 106 may provide the code snippet 207 to the publisher 104 and/or the user access device 108. The code snippet can originate and/or be provided from other sources. As the requesting user device 108 loads the content page 208, the code snippet 207 causes the user device 108 to contact the AMS 106 and receive additional code (e.g., Java Script® or the like), which causes the content page 208 to load with an ad portion 212.

The ad portion 212 may include any element that allows information to be embedded within the content page 208. In some examples, the ad portion 212 may be implemented as an HTML element, such an I-Frame (inline frame) or other type of frame. The ad portion 212 may be hosted by the AMS 106 or the publisher 104 and may allow content (e.g., ads) from the AMS 106 or the publisher 104 to be embedded inside the content page 208. Parameters associated with the ad portion 212 (e.g., its size and shape) can be specified in the content page 208 (e.g., in HTML), so that the user access device 108 can present the content page 208 while the ad portion 212 is being loaded. Other implementations of ad portion 212 may also be used.

The ad portion 212 may send the AMS 106 formatting and content information 214. This information 214 may include information describing the manner (e.g., how, when, and/or where) in which ads can be rendered by the user access devices 108. The information 214 may also include ad attributes and parameters, such as size, shape, color, font, presentation style (e.g., audio, video, graphical, textual, etc.), etc. The information 214 may also specify a quantity of ads desired.

The formatting and content information 214 can also include information associated with the content 210 displayed in content page 208. Such information may include a URL (Universal Resource Locator) associated with the requested content page 208. In some implementations, the information 214 can include the requested content itself, a category corresponding to the requested content or the content request, part or all of the content request 206, content age, content type (e.g., text, graphics, video, audio, mixed media, etc.), geo-location information, and the like.

In response to the information 215, the AMS 106 may provide the user access device 108 with ad information 216. The ad information 216 may include one or more ads 225 for placement in the ad portion 212 of the content page 208. The ad information 216 may also include a signed or encoded specification of an ad.

The ad information 216 may include ads that are relevant to user interest. The AMS 106 may retrieve and provide relevant ads based on the information 214 received from the user access device 108. The AMS 106 may retrieve the ad information 216 from the ad repository 126. The AMS 106 may retrieve relevant ads using information from a crawling module, various keywords, various statistical associations between ads and content, and/or preference information associated with the publishers.

The ad portion 212 may populate with ads included in the information 216, such as ads 225. The ad portion 212 and the displayed ads 225 may occupy a portion of the content page 208, which may be distinct from other content (e.g., the content 210) in the content page 208.

When a user clicks on the displayed ad 225, an embedded code snippet may direct the user access device 108 to contact the AMS 106. During this event, the user access device 108 may receive an information parcel, such as a signed browser cookie, from the AMS 106. This information parcel can include information, such as an identifier of the selected ad 225, an identifier of the publisher 104, and the date/time the ad 225 was selected by the user. The information parcel may facilitate processing of conversion activities or other user transactions.

The user access device 108 may then be redirected to the advertiser 102 associated with the selected ad 225. The user access device 108 may send a request 218 to the associated advertiser 102 and then load a landing page 220 from the advertiser 102. The user may then perform a conversion action at the landing page 220, such as purchasing a product or service, registering, joining a mailing list, etc. A code snippet, which may be provided by the AMS 106, may be included within a conversion confirmation page script, such as a script within a web page presented after the purchase. The user access device 108 may execute the advertiser code snippet, which may then contact the AMS 106 and report conversion data to the AMS 106. The conversion data may include conversion types and numbers as well as information from cookies. The conversion data may be maintained in the conversion data repository 136.

During data flow 200, one or more frontend modules in the AMS 106 may perform one or more actions to gradually expose features of the AMS 106 to the advertisers 102 as features become useful or relevant. For example, the frontend modules may gradually add features to the ad feature set 202, for example, as those additional features become useful to the advertisers. Other criteria for adding features to the ad feature set are possible, including those associated with sophistication of the user, amount of time the product has been accessed/enabled, number of ads requested, etc. In some examples, the frontend modules may change the ad feature set 202 based on account information associated with the advertisers 102, the ad performance with respect to particular publishers, ad performance with respect to a specific location, aggregated information from multiple advertiser accounts, the expiration of certain preset time periods, and other information.

FIG. 2 is an example only and not intended to be restrictive. Other data flows may therefore occur in the environment 100 and, even with the data flow 200, the illustrated events and their particular order in time may vary. Further, the illustrated events may overlap and/or may exist in fewer steps. Moreover, certain events may not be present and additional and/or different events may be included.

In alternative data flows, the publisher 104 can send an ad request to the AMS 106 prior to sending a content page to the user access device 108. The AMS 106 may respond by sending relevant ads to the publisher 104. The publisher 104 may combine the received ads with requested content in the content page and then send the content page, including the ad portion, to the user access device 108 for display to a user. Other modifications to the data flow 200 are also possible.

In alternative data flows, the AMS 106 may target ads to the user access devices 108 based on search terms provided by the user access devices 108. In these dataflows, the AMS 106 may provide searching services and receive search terms directly from the user access devices. The AMS 106 can also receive search terms from a dedicated searching system that receives user search requests. The AMS 106 may target ads to the user access devices based on the received search terms and ad keywords provided by the advertisers.

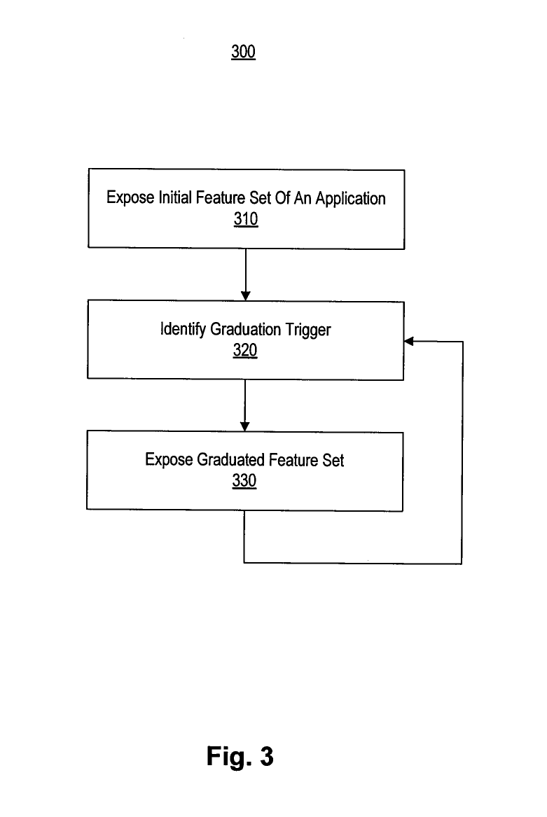

FIG. 3 is a flow diagram illustrating an example feature transition process 300. In some implementations, the process 300 may be performed by one or more elements in the AMS 106, such as the advertiser frontend module. The process 300 can be performed by other systems in conjunction with or instead of the AMS 106. The process 300 may expose an initial feature set of an application (310), identify a graduation trigger (320), and expose a graduated feature set based on the graduation trigger (330).

Exposing an initial feature set of an application (310) may include establishing a session between a user and the application. For example, a user can login into an advertising application provided by the AMS 106 to establish a session with the application. Establishing a session may involve performing various known identification and authentication procedures.

Exposing an initial feature set (310) may involve providing a user interface (e.g., a GUI) that exposes or presents a limited set or subset of features available from the application. For example, the AMS 106 may expose a basic set of features for creating a single textual ad, selecting keywords, selecting a single region for ad placement, and setting currency and pricing. The initial feature set may be determined based on stored user account information. For example, the user account information may include an access level specifying a set of features. In other examples, each feature of the application may be associated with a set of rules. The stored account information may be analyzed using the rules to determine the initial feature set.

The process 300 may identify a graduation trigger (320). Identifying a graduation trigger may involve identifying a basis for exposing an additional feature of the application to a user as well as additional user interface complexity associated with the additional feature. The basis for exposing an additional feature may be identified or determined, for example, from explicit instructions received from a user and/or from an analysis of information associated with users (e.g., user account structure).

Identifying a graduation trigger (320) may also involve identifying a basis for removing or simplifying a feature of the application or a user interface. The basis for removing or simplifying features and interfaces may be identified or determined, for example, from instructions received from a user and/or from an analysis of various information.

In some examples, graduation triggers may include user commands and/or selections. For example, a user of the initial feature set may input a command to access an additional feature not available in the initial feature set. This command may indicate a user need for the additional feature and serve as a basis for exposing the additional feature. As an example, an advertiser using the initial feature set may input a command to create multiple ads. This selection may provide a basis for exposing additional features and user interface complexity associated with creating and managing multiple ads.

In other example, a user of the initial feature set may input a command to remove a feature in the initial feature set. This selection may serve as a basis for removing or simplifying the feature or interface.

Identifying a graduation trigger (320) may involve identifying activities associated with a user of the initial feature set. Activity-based graduation triggers may include various user activities, such as user selections of certain options and attempts by users to perform functions not include in the initial feature set. These activities may provide a basis for exposing additional features.

In some examples, identifying an activity-based graduation trigger may involve identifying that a user performs an action multiple times. For example, the identifying may involve identifying that a user has edited six keyword bids in a row. This activity may serve as a basis for exposing a feature for editing bids in bulk (e.g., increasing bids by 10%, which saves time).

In other examples, identifying an activity-based graduation trigger may involve identifying that a user pauses all their ad campaigns every day. This activity may serve as a basis for exposing a feature that allows a user to set the time of day when their ad campaigns will run, thus eliminating the manual effort.

Identifying activity-based graduation triggers can also include identifying a lack of usage of a feature. For example, the identifying may involve identifying that a user of the initial feature set has not used a particular feature of the initial feature set for certain period of time. This usage information may serve as a basis for removing or simplifying features of the initial feature set.

Graduation triggers may also be based on time. Identifying a time-based graduation trigger may involve identifying the expiration of an amount of time. For example, identifying a time-based trigger may involve identifying that an account of an advertiser using the initial feature set has been active for three-months. This may serve as a basis for exposing an additional feature, such as a feature commonly used by other advertisers at that point in time.

The amount of time used for the trigger may be predetermined or dynamically determined. In some examples, the trigger time may be determined based on feature usage associated with users. For example, the trigger time may be based on a determination that several advertisers 102 began using an ad conversion tracking feature three months after establishing an account with the AMS 106.

Identifying a graduation trigger (320) may involve collaborative filtering. This may involve aggregating account information or feature usage information for multiple users and fitting a particular user's information to that aggregated information. As an example, collaborative filtering may involve comparing the initial feature set provided to a first user with an aggregated “model” feature set. The model feature set may represent an aggregation of features being provided to other similarly situated users. Discrepancies between the initial feature set and the model feature set may serve as a basis for exposing additional features to the first user.

As another example of collaborative filtering, information related to the performance of ads from multiple advertisers could be aggregated to identify average performance markers. In this example, the performance of ads from a given advertiser using the initial feature set could be compared with the average performance markers. Discrepancies between the advertiser's ad performance and the average performance markers may serve as a basis for exposing additional features.

In some implementations, identifying a graduation trigger (320) may involve identifying transactions associated with a user of the initial feature set. For example, trends can be identified based on a user's transaction history. These trends may serve as a basis for exposing additional features to the user.

Identifying a graduation trigger (320) may additionally or alternatively involve identifying triggers based on various performance statistics. Performance statistics can include financial performance statistics, usage statistics, return on investment statistics, and the like. With advertising, performance statistics can include, for example, general ad performance, ad performance with respect to location, and ad performance with respect to publisher sites. As an example, identifying a graduation trigger may involve identifying that an ad is performing above average on particular publisher site. This trigger may serve as a basis for exposing additional features related to site targeting. As another example, identifying a graduation trigger may involve identifying that an ad is performing above average in a specific location. This may serve as a basis for exposing additional features related to location-based ad targeting.

Identifying a graduation trigger (320) may involve identifying a graduation trigger based on the content of an ad, the structure of an ad and/or the targeting of an ad. For example, identifying a graduation trigger may involve identifying that an ad created by an advertiser using the initial feature set is a textual ad. This may serve as a basis for exposing additional features that allow advertisers to create graphics for ads. In another example, identifying a graduation trigger may involve identifying certain words included in an ad and comparing those words with information stored in a database to determine potential markets for the ad. An identification of potential untapped markets may serve as a basis for exposing additional features related to ad targeting.

In yet another example, identifying a graduation trigger may involve identifying that an advertiser using the initial feature set has targeted an ad to a particular location. For example, the identifying may involve determining that the ad is targeted to a 25 mile radius of a business location. These triggers may serve as a basis for exposing additional features related to ad targeting, such as features that allow advertisers to promote location-based products and services to local customers in a given area.

In some implementations, identifying a graduation trigger (320) may involve identifying the adoption of another feature. As an example, the initial feature set may include an option for an advertiser to manually enter bids rather than use an automatic bid optimizer. If the advertiser begins manually entering bids, additional bidding and ad positioning features may be useful to the advertiser. In this example, identifying a graduation trigger may involve identifying that the advertiser is manually entering bids. This activity may serve as a basis for exposing additional features related to bidding an ad positioning.

In some implementations, identifying a graduation trigger may further involve identifying an additional application feature based on an identified graduation trigger. For example, an additional feature for adding multiple campaigns may be identified based on the trigger of a user selection or command to add multiple ads. In another example, the process 300 may identify an additional application feature for tracking conversions based on the trigger of an expiration of a time period (e.g., three months).

In some implementations, identifying an additional application feature based on a trigger may involve inferring a need or usefulness for additional features based on the triggers. This may involve accessing associations or correlations between graduation triggers and additional features. For example, an expiration of a three-month time period may be associated with an additional feature for tracking conversions while an expiration of a six-month time period may be associated with an additional feature for adding graphics to ads. In another example, a certain performance aspect of an ad may be associated with a keyword tool or other analytical feature. Other techniques can also be used to identify and infer usefulness of additional applications.

Identifying additional features based on the triggers may also involve accessing stored rules associated with additional features. The rules may specify certain constraints on access to additional features. For example, the rules may specify that certain features are not available to certain user groups. The associations and rules may, for example, be stored in one or more repositories maintained by the AMS 106.

The process 300 may expose a graduated feature set based on the identified graduation trigger (330). The graduated feature set may include a feature set that is different than the initial feature set. The graduated feature set can include additional features not included in the initial feature set. For example, the graduated feature set can include features for allowing an advertiser 102 to create multiple campaigns, create multiple ad groups within each campaign, add graphics to ads, view detailed reports and analyses, select multiple regions for placement of an ad, access various keyword and other targeting tools, etc. In some examples, one or more features included in the initial feature set may be absent from the graduated feature set or simplified in the graduated feature set. For example, an initial feature may be replaced by a graduated feature or removed or simplified for some other reason (e.g., lack of relevancy, user instructions, lack of use by user, etc.).

Multiple features included in the graduated feature set can be exposed at the same time. In addition, graduated features may be exposed at different times, with some features only being exposed if other features are adopted by users. Further, as illustrated in FIG. 3, the process 300 may continually identify graduation triggers and expose graduated feature sets.

In some implementations, exposing a graduated feature set may include selecting features to include in the graduated feature set. This selection may be based on the identified graduation triggers. The selection could also be performed using various associations between triggers and features and rules associated with the features.

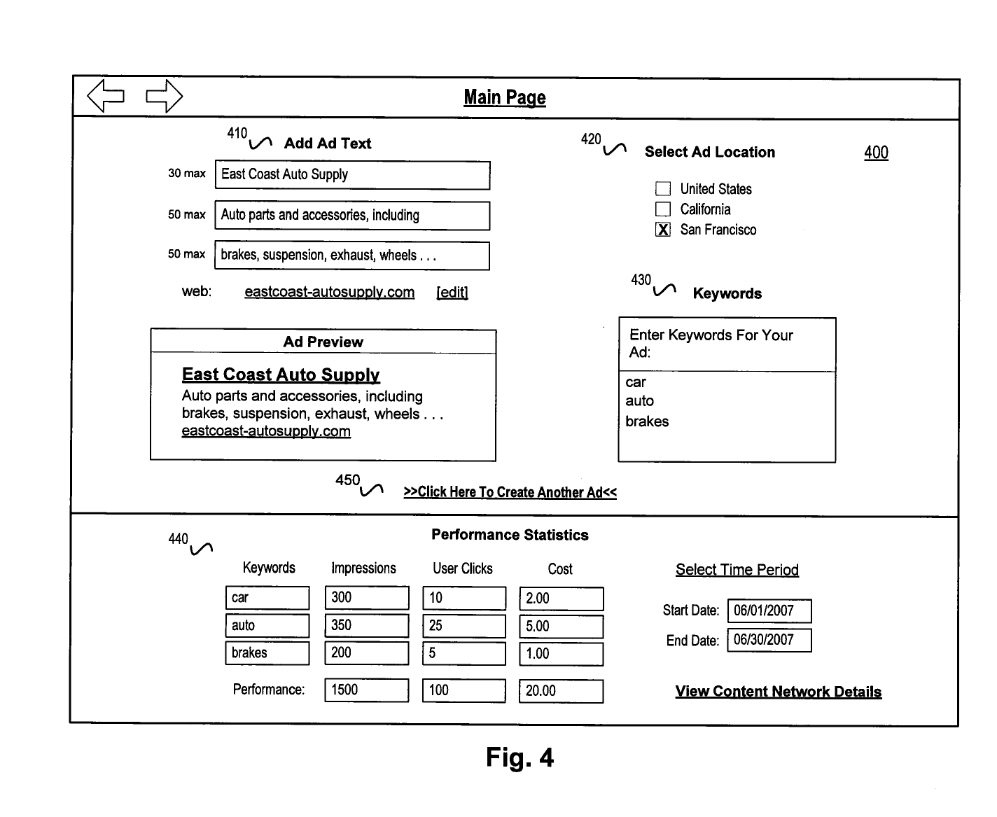

Exposing the graduated feature set (330) may involve presenting to a user of the initial feature set one or more selectable options (e.g., links) for adopting or utilizing an additional feature. In some examples, the selectable options may be presented in a user interface providing access to the initial feature set. As an example, a user interface generated by the advertiser frontend and providing access to the initial feature set may present a selectable link to features associated with creating multiple ads or multiple campaigns. This is illustrated in the example user interface display 400 of FIG. 4. The display 400 may be provided by the advertiser frontend and may expose features included in the initial feature set, such as features 410, 420, 430 and 440. The display 400 may also present a link 450 to an additional feature for creating multiple ads.

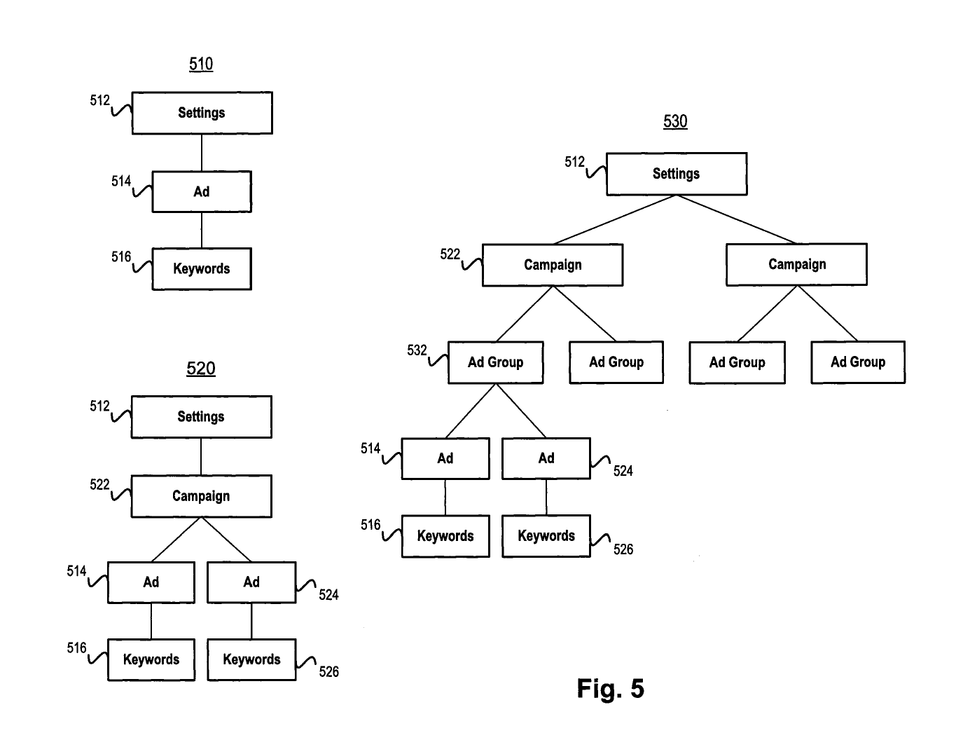

In some implementations, exposing the graduated feature set (330) may involve modifying the structure and complexity of a user interface exposing the initial feature set. This is illustrated in FIG. 5, which depicts example interface structures 510, 520 and 530 that can be used with an advertising application provided by the AMS 106.

The interface structure 510 in FIG. 5 may be associated with the initial feature set. If the initial feature set allows an advertiser to create only a single ad, the interface structure 510 may include account settings 512, a single ad 514, and its keywords 516. The settings 512 may include user e-mail addresses and other contact information, passwords, billing information, user preferences and other user information.

If an additional feature for creating multiple ads is exposed, then the interface structure 510 may be modified so that it is similar to the interface structure 520. Like the structure 510, the interface structure 520 includes the settings 512. The interface structure 520 further includes a campaign 522, which may include one or more ads 514, 524 and their keywords 516, 526. The campaign 522 may include information such as a campaign name, start/end dates for the campaign, budget information, campaign distribution preferences, language and location targets, and other information.

If an additional feature for creating multiple campaigns is exposed, then the interface structure 520 may be modified so that it is similar to the interface structure 530. The interface structure 530 includes the settings 512 as well as multiple campaigns 522. The structure 530 also includes one or more ad groups 532 for each campaign. Ads (e.g., 514, 524) and their keywords (e.g., 516, 526) are arranged in the ad groups 532. The ad groups 532 may allow an advertiser to organize ads within a campaign. In this fashion, the structure and complexity of a user interface may gradually progress or change as additional features are exposed to users.

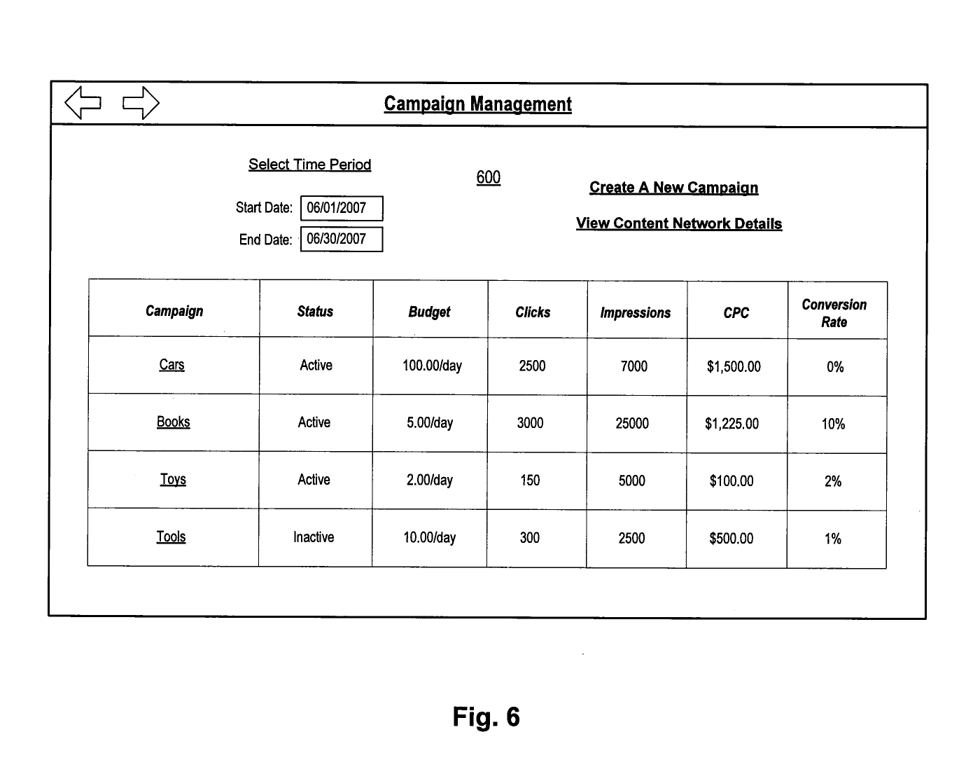

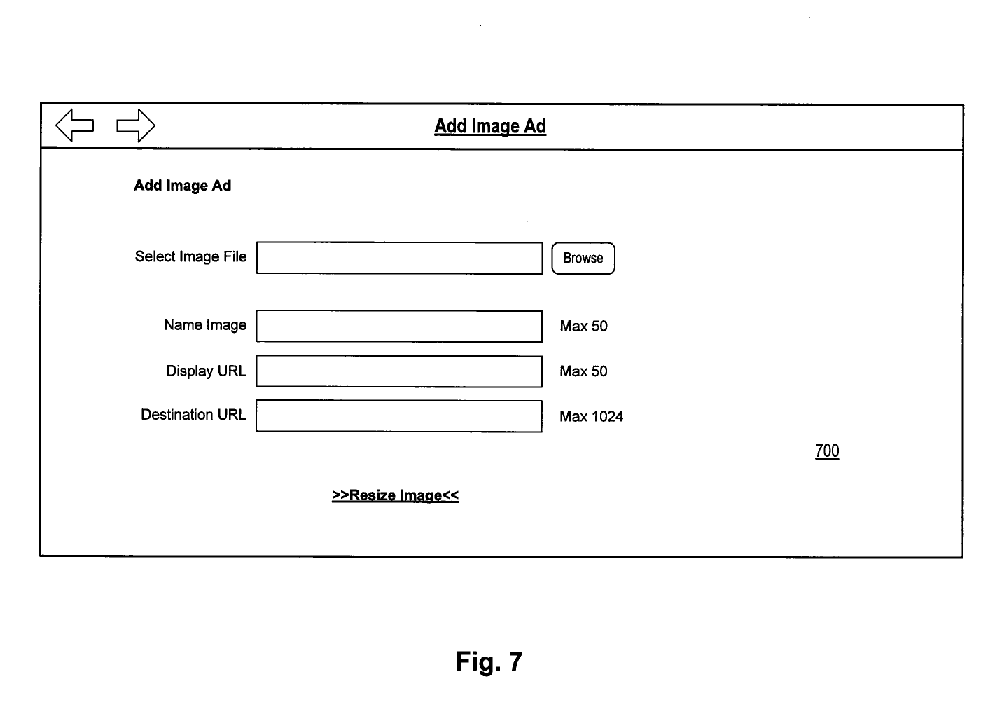

Referring again to FIG. 3, exposing the graduated feature set (330) may involve allowing users to access functionality associated with the graduated feature set. This may involve modifying a user interface that exposes the initial feature set to provide such access. FIGS. 6 and 7 show example user interface displays 600 and 700 that provide access to functionality associated with graduated features. The display 600 provides access to campaign management features, and the display 700 provides access to a graphics feature. Exposing the graduated feature set (330) may involve generating these interface displays as the respective features are exposed.

In addition to exposing the graduated feature set, the process 300 may also expose or trigger other items to users. These other items can be exposed or triggered, for example, based on graduation triggers or features in the initial and/or graduated feature sets. As an example, various messages, tools, help bubbles, callouts, tutorials and the like can be exposed as additional features are exposed. Access to a help center can also be provided. These additional items may, for example, provide an explanation of the additional features and provide guidance for using the additional features.

FIGS. 3-7 are consistent with example implementations. The sequence of events in FIG. 3 is an example and not intended to be limiting. Other processes may therefore be used and, even with the process depicted in FIG. 3, the illustrated events and their particular order in time may vary. Further, the illustrated events may overlap and/or may exist in fewer steps. Moreover, certain events may not be present and additional events may be included in the illustrated processes.

### Example Data Processing System Configuration

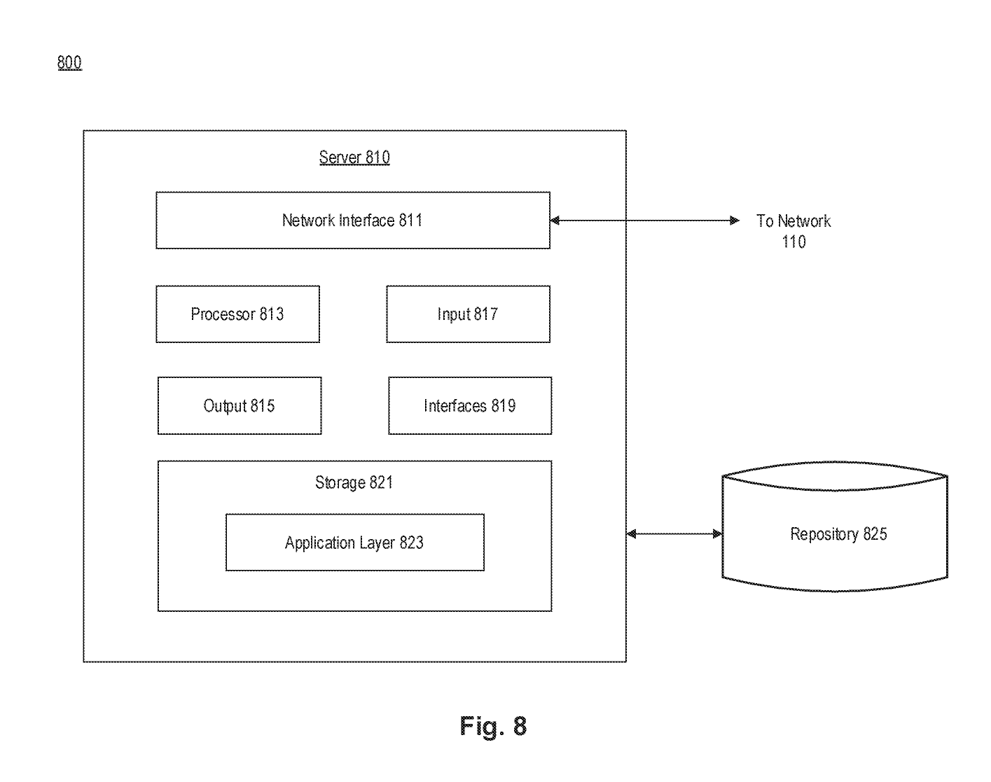

FIG. 8 illustrates an example configuration 800 of a server system 810. In some implementations, the data processing systems 112, 114 and 116 depicted in FIG. 1 could be configured in a manner consistent with configuration 800. The configuration 800 is an example only, and the systems 112, 114 and 116 could be configured in other ways. Further, each of the servers could have its own individual structure and configuration. Moreover, as noted above, the functions provided by the systems 112, 114 and 116 could be performed by a single server computer or could be performed by a single server process running on a single computer.

In the configuration 800, the server 810 may include various components, such as a network interface 811, a processor 813, an output 815, an input 817, interfaces 819, and a storage 821. One or more system buses (not illustrated) may interconnect these components. The number, identity and arrangement of elements in the configuration 800 are not limited to what is shown, and additional and/or different elements may be contained in or coupled to the elements shown. Further, configuration 800 may include fewer components than what is illustrated.

The network interface 811 may facilitate connectivity with a network, such as the network 110. Network interface 811 may be any appropriate wireline (e.g., IEEE 1394, USB, etc.) or wireless (e.g., IEEE 802.11™, Bluetooth®, IrDA®, etc.) mechanism for facilitating unidirectional or bidirectional transmission of data between the server 810 and a network. The network interface 811 may include one or more network cards and/or data and communication ports.

The processor 813 routes information among components and executes instructions from storage 817. Although FIG. 8 illustrates a single processor, the server 810 may include any number of general- and/or special-purpose processors. The processor 813 may be implemented, for example, using one or more commercially available INTEL® processors.

The output 815 may present text, images, video, audio, or any other type of information. Examples of the output 815 include, video display devices, audio display devices, printers, and the like. The output 815 may display user interface information for various software applications running on the server 810, as well as the operating system programs necessary to operate the system. The output 815 may present information by way of a cathode ray tube, liquid crystal, liquid crystal on silicon, light-emitting diode, gas plasma, laser, or other type of display mechanism. The output 815 could also be configured to receive, generate and/or present holographic or other visual representations. The output 815 may be configured to audibly present information, and it may include suitable components for receiving and presenting audio signals. Although FIG. 8 illustrates a single output 815, the server 810 may include any number of similar or different output devices.

The input 817 may include components such as a keyboard, a mouse, a pointing device, a joystick, and/or a touch screen. The input 817 may also include audio- or video-capture devices (e.g., video cameras, microphones, etc.) and/or various sensors for sensing emissions (e.g., thermal, motion, sound, etc.). It may also include one or more information reading devices (e.g., scanners, disk drives, etc.) and/or input ports. Although FIG. 8 depicts the input 817 as a single discrete element, the server 810 may include any number of similar or different input devices. For example, the server 810 could include a keyboard and a mouse as well as a video-capture device, a scanner and several disk drives.

A user of the server 810 may input commands to control and operate functionality of the server 810 by way of the output 815 and the input 817. These commands may, for example, be input by way of user manipulation of physical controls, such as a keyboard or mouse. The user may input commands to select and manipulate graphics and text objects presented on the output 815 in order to operate and control the server 810.

The interfaces 819 may include various interfaces for facilitating bidirectional or unidirectional communication between the server 810 and one or more peripheral or other devices. The peripheral devices may include, for example, output devices (e.g., a monitor, a printer, a speaker, etc.), input devices (e.g., a keyboard, a mouse, a scanner, etc.), or any other device operable to connect to the server 810. The interfaces 819 may include a combination of hardware, software and/or firmware components. The interfaces 819 may include various connection ports, such as USB, RS-232, RS-485, Fibre Channel, Ethernet, IEEE 1394, RG-6, and/or TOSLINK.

The storage 821 may provide mass storage and/or cache memory for the server 810. The storage 821 may be implemented using a variety of suitable memory elements. The memory elements may include, for example, solid state elements, optical elements, polymer elements, magnetic elements, and/or organic elements (e.g., crystals). The memory elements may be volatile or non-volatile and may be randomly or sequentially accessed. The storage 821 may include random access memory (RAM), flash RAM, read-only memory (ROM), erasable programmable read-only memory (EPROM), and electrically erasable programmable read-only memory (EEPROM). The storage 821 may include one or more fixed disk drives (e.g., a hard drive, RAID storage, etc.) and one or more removable disk drives (e.g., a CD-ROM drive, DVD drive, etc.). Although a single storage module is shown, the server 810 may include any number of individually configured storage modules.

The storage 821 may store program code for various applications, an operating system (e.g., Windows® XP, Linux® OS), an application-programming interface, application routines, middleware components, and/or other executable instructions. The storage 821 may include program code and information for communications (e.g., TCP/IP communications), middleware components, kernel and device drivers, invariant low-level systems code, data for basic input and output, and various configuration information.

The storage 821 may maintain an application layer 823, which may include various software programs and modules. Such programs and modules could be transferred to a hard drive (not shown) in the storage 821 by way of network transmissions (e.g., an Internet download) and/or removable disks (also not shown), such as a CD-ROM or DVD.

In the configuration 800, the server 810 may be coupled to one or more repositories 825. In some examples, the repositories 124, 126, 136 and 146 may be implemented in a manner consistent with the repositories 825. The repository 825 may include any structured collection or aggregation of information that is stored and accessible. In some implementations, the repositories 825 may include one or more structured data archives distributed among one or more network-based data processing systems. The repositories 825 may include one or more schemas for organizing stored information. In some examples, the repositories 825 may include one or more relational databases and systems, distributed databases, object-oriented databases, and/or any other types of databases. Examples of databases include Oracle® databases, IBM DB2® systems, MySQL® databases, XML databases, and the like. Although illustrated as coupled to the server 810, the repositories 825 could be distributed and/or included in various systems and/or networks.

### Example Application Layer Configuration

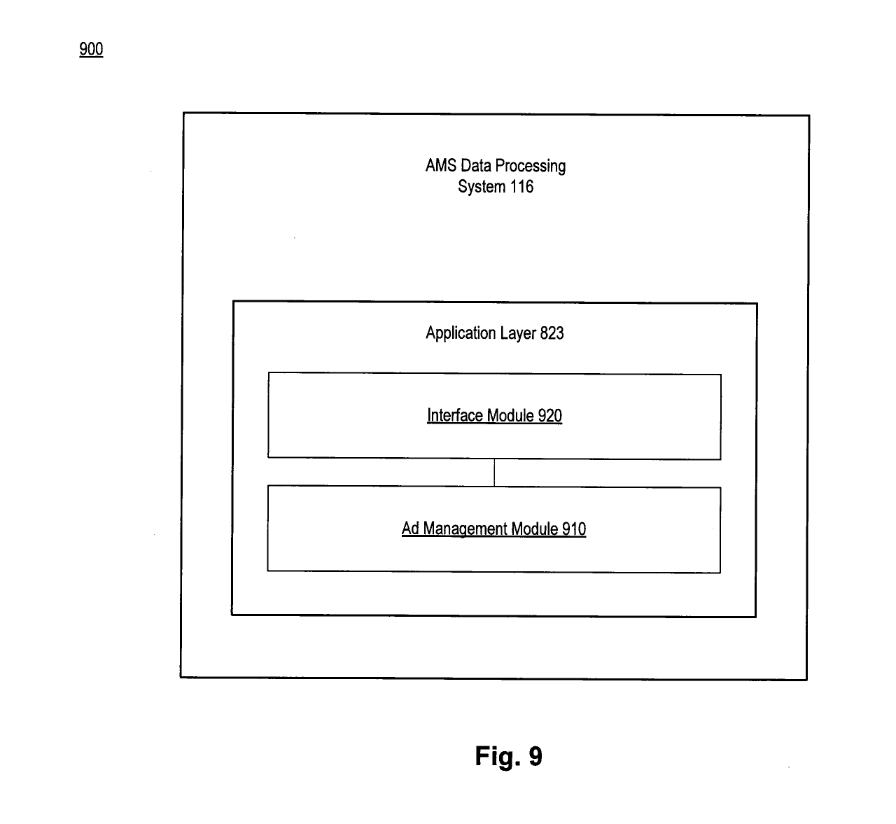

FIG. 9 is a block diagram of an example configuration 900 of the application layer 823, which may be maintained in the storage 821 of the server 810. The configuration 900 may represent the configuration of an application layer of a data processing system (e.g., the system 116) maintained by the AMS 106. As illustrated in FIG. 9, the application layer configuration 900 may include an ad management module 910 and an interface module 920.

The modules 910 and 920 may include and/or use one more data structures as well as one or more computational algorithms that may operate on various data. The modules may include sets of instructions for performing various tasks, and the modules may output information for use by users or other systems. In some implementations, the modules may include one or more engines, which may output code (e.g., source code, HTML, etc.) that serves as input to other systems, engines or processes.

The modules 910 and 920 may be implemented using any programming or other language suitable for controlling behavior of a system, such as a computer. In some examples, the modules 910 and 920 may be implemented using one or more of C/C++, Java, Visual Basic, eXtendible Markup Language (XML), HTML and other languages.

Although depicted within software application layer 823, the modules 910 and 920 could include and/or be coupled to various hardware elements (within or external to the server 810). For example, the modules could include one or more neural networks, which may employ software and hardware processing elements or agents linked together. In some examples, the modules could include or use one more embedded systems, such as microcontrollers, routers, etc.

The ad management module 910 may be configured to provide various advertising features, such as features for creating ads, managing ads, analyzing ad performance, targeting ads, etc. In some implementations, the ad management module 910 may be configured to provide features associated with AdWords™ and/or AdSense™ provided by Google, Inc.

The interface module 920 may be configured to generate user interfaces that allow users to access and interact with features of the ad management module 910. The interface module 920 may serve as a “frontend” to the ad management module 910. In some examples, the interface module 920 may be a web application written in Java. The interface module 920 may be configured to perform one or more actions to gradually expose features of an application, such as the features of the ad management module 910. The interface module 920 may be configured to communicate with one or more other modules and systems to perform this functionality. For example, the interface module 920 may communicate with other systems to evaluate keyword quality. In some implementations, the interface module 920 may store and/or execute operations consistent with the process 300 illustrated in FIG. 3.

### Example User Access Device Configuration

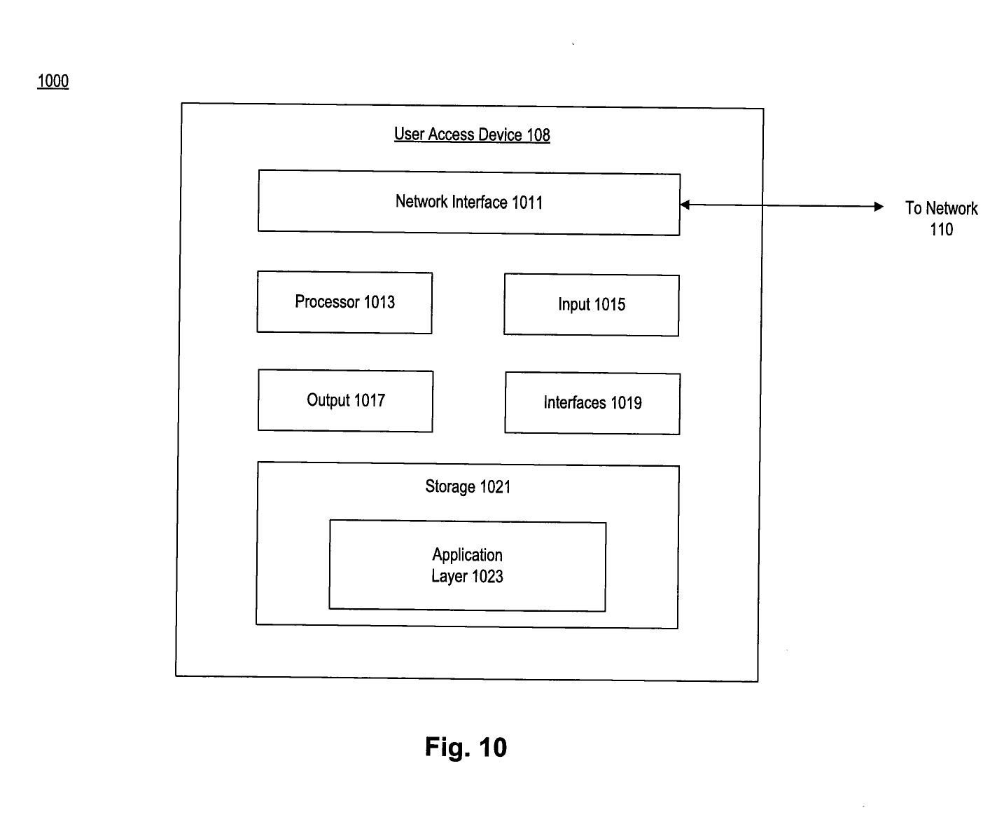

FIG. 10 is a block diagram of an example configuration 1000 of the user access devices 108 in environment 100. The number, identity and arrangement of elements in the configuration 1000 are not limited to what is shown, and additional and/or different elements may be contained in or coupled to the elements shown. The configuration 1000 is an example only, and the user access device 108 could be configured in other ways.

In the example configuration 1000, the user access devices 108 may include various components, such as a network interface 1011, a processor 1013, an output 1015, an input 1017, interfaces 1019, and a storage 1021, which may maintain an application layer 1023. The components illustrated in FIG. 10 (i.e., 1011, 1013, 1015, 1017, 1019, 1021, and 1023) may be similar in structure and functionality to those components described in connection with FIG. 8 (i.e., 811, 813, 815, 817, 819, 821, and 823). In some implementations, however, one or more of the user access devices 108 may include components that are structurally and functionally different from those described in connection with FIG. 8. For example, the user access devices 108 may be configured with different (e.g., less) storage capacity and different application layers than the server system. In some examples, the application layer 1023 in a user access device may include one or more modules configured to present various viewers (e.g., browsers) to users. The application layer 1023 may also include one or more modules for interacting with other elements (e.g., data processing systems 112, 114 and/or 116), receiving and processing ads, and/or combining received ads with received content for presentation to users.

The user access devices 108 could also be configured with less or different processing capabilities than that of the server system. In some examples, the user access devices 108 may include various user interface components (e.g., keypads, display devices, speakers, microphones, etc.) while the server system may lack such (or even any) user interface components. In some examples, the server system 810 could be a general purpose server while the user access devices 108 could include embedded systems optimized with specific components for performing specific tasks.

The foregoing description does not represent an exhaustive list of all possible implementations consistent with this disclosure or of all possible variations of the implementations described. Other implementations are within the scope of the following claims.

1. A method comprising:
receiving a user profile comprising one or more characteristics of a first user of an online advertising management application;
determining, by executing logic representing a set of rules for the one or more characteristics, a first subset of available application functionalities, with each of the available application functionalities comprising one or more first interactive controls for managing content;
providing, to a computer used by the first user of the online advertising management application over the Internet, a user interface that displays the first subset of the available application functionalities;
aggregating user profiles of second users;
based on the aggregated user profiles, determining one or more of the second users that each has a user profile with at least a threshold amount of similarity to the user profile of the first user;
determining a second subset of the available application functionalities, with each available application functionality in the second subset having been presented to the one or more second users;
comparing the available application functionalities in the first subset to the available application functionalities in the second subset;
based on comparing, identifying one or more of the available application functionalities in the second subset that (i) have been presented to the one or more second users that each has the user profile with at least the threshold amount of similarity to the user profile of the first user and (ii) are not included in the first subset of the available application functionalities presented to the first user;
identifying one or more conditions for enabling access through the user interface of one or more second interactive controls for managing content of the one or more of the available application functionalities identified in the second subset that (i) have been presented to the one or more second users that each has the user profile with at least the threshold amount of similarity to the user profile of the first user, and (ii) are not included in the first subset of the available application functionalities presented to the first user through the user interface;
based on the identified one or more conditions, selecting at least one of the one or more second interactive controls of the one or more of the available application functionalities identified in the second subset for enabling the first user to access through the user interface, with the at least one of the one or more of the available application functionalities differing from each of the available application functionalities in the first subset;
enabling the first user to access, over the Internet and through the user interface, the at least one of the one or more second interactive controls of the one or more of the available application functionalities;
generating an online advertisement using the at least one of the one or more second interactive controls for which access is enabled; and
serving, by one or more processing devices over the Internet, the online advertisement to one or more client devices.

2. The method of claim 1, further comprising:
placing the online advertisement on an interactive medium.

3. (canceled)

4. The method of claim 1, further comprising:
generating information for changing a hierarchical structure of the user interface.

5. (canceled)

6. (canceled)

7. The method of claim 1, further comprising:
identifying a structure of a user profile for at least one of the second users in a database;
wherein determining one or more of the second users that each has a user profile with at least a threshold amount of similarity to the user profile of the first user is based on the identification of the structure of the user profile.

8. The method of claim 1, further comprising:
accessing first information in the user profile of the first user;
accessing second information in one or more of the user profiles for the second users;
identifying a difference among the user profile and at least one of the one or more of the user profiles of the second users; and
wherein selecting comprises:
selecting, based on the difference, the at least one of the available application functionalities in the second subset.

9. The method of claim 8, wherein one or more of the first information and the second information comprises information indicative of stored financial transactions.

10. The method of claim 8, wherein the first information comprises a performance statistic associated with an account of the first user.

11. The method of claim 10, wherein one or more of the first information and the second information comprises a financial performance statistic.

12. The method of claim 1, wherein the online advertisement comprises a first online advertisement, and wherein the method further comprises:
identifying a performance of a second online advertisement managed by the online advertising management application; and
wherein selecting the at least one of the available application functionalities in the second subset is based on the identification of the performance of the second online advertisement.

13. The method of claim 12, wherein identifying the performance of the second online advertisement comprises identifying the performance of the second online advertisement in a geographic region.

14. The method of claim 12, wherein identifying the performance comprises determining an expected increase in the performance of the second online advertisement.

15. The method of claim 1, further comprising:
determining at least one user benefit associated with the at least one of the available application functionalities in the second subset.

16. The method of claim 1, further comprising:
presenting an option to add the at least one of the available application functionalities in the second subset to the user interface.

17. The method of claim 1, further comprising:
transmitting, to the computer used by the first user, information specifying a description of the at least one of the one or more second interactive controls of the one or more of the available application functionalities for enabling the first user to access in the user interface.

18. A system comprising:
one or more processing devices; and
one or more computer-readable hardware storage devices storing instructions that are executable by the one or more processing devices to perform operations comprising:
receiving a user profile comprising one or more characteristics of a first user of an online advertising management application;
determining, by executing logic representing a set of rules for the one or more characteristics, a first subset of available application functionalities, with each of the available application functionalities comprising one or more first interactive controls for managing content;
providing, to a computer used by the first user of the online advertising management application over the Internet, a user interface that displays the first subset of the available application functionalities;
aggregating user profiles of second users;
based on the aggregated user profiles, determining one or more of the second users that each has a user profile with at least a threshold amount of similarity to the user profile of the first user;
determining a second subset of the available application functionalities, with each available application functionality in the second subset having been presented to the one or more second users;
comparing the available application functionalities in the first subset to the available application functionalities in the second subset;
based on comparing, identifying one or more of the available application functionalities in the second subset that (i) have been presented to the one or more second users that each has the user profile with at least the threshold amount of similarity to the user profile of the first user and (ii) are not included in the first subset of the available application functionalities presented to the first user;
identifying one or more conditions for enabling access through the user interface of one or more second interactive controls for managing content of the one or more of the available application functionalities identified in the second subset that (i) have been presented to the one or more second users that each has the user profile with at least the threshold amount of similarity to the user profile of the first user, and (ii) are not included in the first subset of the available application functionalities presented to the first user through the user interface;
based on the identified one or more conditions, selecting at least one of the one or more second interactive controls of the one or more of the available application functionalities identified in the second subset for enabling the first user to access through the user interface, with the at least one of the one or more of the available application functionalities differing from each of the available application functionalities in the first subset;
enabling the first user to access, over the Internet and through the user interface, the at least one of the one or more second interactive controls of the one or more of the available application functionalities;
generating an online advertisement using the at least one of the one or more second interactive controls for which access is enabled; and
serving, by one or more processing devices over the Internet, the online advertisement to one or more client devices.

19. The system of claim 18, wherein the operations further comprise:
determining a need for the one or more of the available application functionalities in the second subset based on identification of a graduation trigger.

20. (canceled)

21. (canceled)

22. The system of claim 18, wherein the operations further comprise:
identifying a structure of a user profile for the at least one of the second users in a database; and
wherein determining one or more of the second users that each has a user profile with at least a threshold amount of similarity to the user profile of the first user based on the identification of the structure of the user profile.

23. The system of claim 18, wherein the operations further comprise:
accessing first information in the user profile of the first user;
accessing second information in one or more of the user profiles for the second users;
identifying a difference among the user profile and at least one of the one or more of the user profiles of the second users; and
wherein selecting comprises:
selecting, based on the difference, the at least one of the available application functionalities in the second subset.

24. The system of claim 23, wherein the first information comprises a performance statistic associated with an account of the first user.

25. The system of claim 18, wherein the online advertisement comprises a first online advertisement, and wherein the operations further comprise:
identifying a performance of a second online advertisement; and
wherein selecting the at least one of the available application functionalities in the aggregation is based on the identification of the performance of the second online advertisement.

26. The system of claim 25, wherein the performance of the second online advertisement is in a geographic region.

27. (canceled)

28. One or more computer readable hardware storage devices storing instructions that are executable by one or more processing devices to perform operations comprising:
receiving a user profile comprising one or more characteristics of a first user of an online advertising management application;
determining, by executing logic representing a set of rules for the one or more characteristics, a first subset of available application functionalities, with each of the available application functionalities comprising one or more first interactive controls for managing content;
providing, to a computer used by the first user of the online advertising management application over the Internet, a user interface that displays the first subset of the available application functionalities;
aggregating user profiles of second users;
based on the aggregated user profiles, determining one or more of the second users that each has a user profile with at least a threshold amount of similarity to the user profile of the first user;
determining a second subset of the available application functionalities, with each available application functionality in the second subset having been presented to the one or more second users;
comparing the available application functionalities in the first subset to the available application functionalities in the second subset;
based on comparing, identifying one or more of the available application functionalities in the second subset that (i) have been presented to the one or more second users that each has the user profile with at least the threshold amount of similarity to the user profile of the first user and (ii) are not included in the first subset of the available application functionalities presented to the first user;
identifying one or more conditions for enabling access through the user interface of one or more second interactive controls for managing content of the one or more of the available application functionalities identified in the second subset that (i) have been presented to the one or more second users that each has the user profile with at least the threshold amount of similarity to the user profile of the first user, and (ii) are not included in the first subset of the available application functionalities presented to the first user through the user interface;
based on the identified one or more conditions, selecting at least one of the one or more second interactive controls of the one or more of the available application functionalities identified in the second subset for enabling the first user to access through the user interface, with the at least one of the one or more of the available application functionalities differing from each of the available application functionalities in the first subset;
enabling the first user to access, over the Internet and through the user interface, the at least one of the one or more second interactive controls of the one or more of the available application functionalities;
generating an online advertisement using the at least one of the one or more second interactive controls for which access is enabled; and
serving, by one or more processing devices over the Internet, the online advertisement to one or more client devices.

29-30. (canceled)

31. The method of claim 1, further comprising:
receiving input through the one or more second interactive controls indicating a graphic to add to the online advertisement;
retrieving, based on searching of a search index, data representing the graphic indicated through the one or more second interactive controls;
updating the online advertisement to include the graphic;
updating keyword data stored with the online advertisement, the keyword data indicating one or more keywords that describe the updated online advertisement; and
enabling the first user to access, over the Internet and through the user interface, an additional application functionality of the one or more of the available application functionalities, the additional application functionality comprising one or more additional interactive controls configured to enable the first user to edit the keyword data stored with the online advertisement.

32. The method of claim 1, further comprising:
searching, by a search module, a data structure storing data representing the user profile of the first user;
determining an account structure of the first user from the data structure;
determining that the first user owns a plurality of accounts; and
identifying an additional application functionality comprising an additional interactive control for presentation to the first user, the additional application functionality configured to enable management of the plurality of accounts.

33. The method of claim 1, further comprising:
detecting one or more interactions of a second user with the one or more second interactive controls; and
for each detected interaction,
determining an amount of time that a second user has had access to a second interactive control associated with the detected interaction; and
when an age of the user profile for the first user corresponds to the amount of time, automatically updating the user interface to include the second interactive control.

34. The method of claim 1, further comprising:
retrieving, from one or more repositories maintained by the online advertising management application, constraint data indicating that one or more particular available application functionalities in the second subset are inaccessible for the first user based on the one or more characteristics of the first user; and
removing, from the second subset of the available application functionalities, the one or more particular available application functionalities in the second subset, wherein the removing prevents the first user from accessing, by the user interface, one or more controls of the one or more particular available application functionalities.
